(19) United States
(12) Patent Application Publication
(10) Pub. No.: US 2025/0223186 A1
(43) Pub. Date: Jul. 10, 2025

(54) SULFUR/CHALCOGENS CONFINED INTO 2D MXENES AS BATTERY CATHODES

(71) Applicant: DREXEL UNIVERSITY, Philadelphia, PA (US)

(72) Inventors: Vibha KALRA, Garnet Valley, PA (US); Rahul Nagesh PAI, Philadelphia, PA (US); Michel W. BARSOUM, Moorestown, NJ (US); Varun R. NATU, Philadelphia, PA (US)

(21) Appl. No.: 18/846,737

(22) PCT Filed: Mar. 17, 2023
(86) PCT No.: PCT/US2023/064613

§ 371 Date: Sep. 13, 2024

Related U.S. Application Data
(60) Provisional application No. 63/321,403, filed on Mar. 18, 2022.

(51) Int. Cl. C01G 23/00; H01M 10/0562; H01M 10/0569

(52) U.S. Cl. CPC C01G 23/002; H01M 10/0562; H01M 10/0569; C01P 2002/01; C01P 2002/08; C01P 2002/72; C01P 2002/85; C01P 2002/88; C01P 2004/03; C01P 2004/04; C01P 2006/40; H01M 2300/0037; H01M 2300/0071

(57) ABSTRACT

A composite that includes a layered MXene comprising at least two layers, and an amount of a chalcogen confined between the at least two layers. An electrode that includes a composite that includes a layered MXene comprising at least two layers, and an amount of a chalcogen confined between the at least two layers. Power cells that include the composite. A method, comprising: with an intercalant spacer, effecting an increase in an interlayer spacing in a multilayered MXene composition; and effecting intercalation of a chalcogen into the interlayer spacing so as to confine the chalcogen between layers of the multilayered MXene composition, and optionally effecting removal of the intercalant spacer.

### CROSS-REFERENCE TO RELATED APPLICATIONS

The present application claims priority to and the benefit of U.S. patent application No. 63/321,403, “Sulfur/Chalcogens Confined Into 2D MXenes As Battery Cathodes” (filed Mar. 18, 2022). All foregoing applications are incorporated herein by reference in their entireties for any and all purposes.

### GOVERNMENT RIGHTS

This invention was made with government support under contract no. 1919177 and contract no. 1740795 awarded by the National Science Foundation. The government has certain rights in the invention.

### TECHNICAL FIELD

The present disclosure relates to the field of MXene materials and to the field of electrode materials.

### BACKGROUND

From the contributions by Goodenough and co-workers to their use in commercial electric vehicles, Li-ion batteries have come a long way with substantial developments in the past three decades^{1,2}. The Li-ion chemistry has now reached its theoretical limit and new battery breakthroughs are necessary for the broad deployment of electric vehicles. Sulfur, S, based-batteries are considered to be some of the most promising ‘beyond Li-ion’ battery systems,³ because elemental S can exhibit a 5 fold higher theoretical capacity than state-of-the-art Li-ion cathodes and is abundant in nature, inexpensive, and environmentally harmless⁴. The consistent developments have led to the maturation of this system, which now offers the capability to supersede the intrinsic limits of Li-ion technology along with cost reductions as well as environmental benignity.

The practicality of S-batteries is, however, hindered by several challenges. The key issues investigated in the literature in this past decade are the insulating nature of S; the inevitable S volume change during cycling⁵⁻⁷; and the dissolution of intermediate reaction products, polysulfides, causing the notorious shuttling effect and rapid capacity fade during cycling.⁸⁻¹⁰

So far, polysulfide shuttling has received the most attention and majority of the works in metal-S batteries in the past decade have focused on the development of strategies to mitigate this effect, which is an inherent phenomenon observed in ether-based electrolytes¹¹.

A much less discussed, but debilitating drawback for the commercial viability of Li—S batteries is the use of the ether electrolyte itself. Ether-based solvents are highly volatile and have low flash points posing a significant risk of operating such batteries beyond room temperatures¹². In addition, Lithium nitrate (LiNO₃), an important additive in ether electrolyte to stabilize Li metal surface causes de-gassing above 40° C. and therefore it doesn't pass test 2 of UN38.3 Transport of Dangerous Goods Certification, further hindering their practicality due to safety and transport concerns¹³. Carbonate-based electrolytes, used in traditional Li-ion batteries have various advantages over their ether-based counterparts. The three decades of research on the former have shown that they have low melting points, lower costs, and higher oxidation potentials¹⁴. However, the S-cathode is not compatible with the conventional carbonate electrolytes, since during discharge the polysulfide anions react with the carbonate solvents irreversibly due to the strong nucleophilic reactions¹⁵. To avoid nucleophilic reactions, recent studies suggest that microporous carbon as a host can effectively suppress the direct contact between the solvent molecule in carbonate-based electrolytes and S (or polysulfide intermediates) molecule due to pore size limitations¹⁶⁻¹⁸. Accordingly, there is a long-felt need in the art for improved sulfur-based batteries and related methods, in particular for such batteries that can operate with carbonate electrolytes.

### SUMMARY

In meeting the described needs, the present disclosure provides a composite, comprising: a layered structure comprising at least two layers, and an amount of a chalcogen confined between the at least two layers.

Also provided is an electrode, comprising a composite according to the present disclosure (e.g., according to any one of Aspects 1-11).

Further provided is a power cell, comprising: a first electrode according to the present disclosure (e.g., according to any one of Aspects 12-15); a second electrode; and an electrolyte, the electrolyte optionally comprising a solid oxide or a sulfide.

Also disclosed is a method, comprising: with an intercalant spacer, effecting an increase in an interlayer spacing in a multilayered composition to give rise to a multilayered composition having enhanced interlayer spacing, the multilayered composition having enhanced interlayer spacing optionally comprising a MXene; and contacting the multilayered composition having enhanced interlayer spacing and the chalcogen to effect intercalation of the chalcogen into the interlayer spacing so as to confine the chalcogen between layers of the multilayered composition, the weight ratio of the chalcogen and the multilayered composition having enhanced interlayer spacing optionally being from about 1:5 to 5:1, and optionally effecting removal of the intercalant spacer so as to give rise to a chalcogen-intercalated multilayered composition.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1: Schematic illustration of fabrication procedure for DMX/S powders

FIG. 2: Morphological characterization of DMX and DMX/S powders: SEM images of a) DMX and b) DMX/S powders (after heat treatment). Scale bar 5 μm. XRD diffraction of c) DMX (orange, bottom), DMX/S after heat treatment (red, middle) and DMX/S (blue, top) powders, d) is same as ‘c’ but only focused on the 2-10 2θ range.

FIG. 3: Electrochemical performance evaluation of DMX/S. (a-d) Li—S system., a. CV curves., b. Charge—discharge curves., c. Cycling stability., d. Rate performance. (e-h) Na—S system., e. CV curves., f. Charge—discharge curves., g. Cycling stability., h. Rate performance. (i-l) K—S system., i. CV curves., j. Charge—discharge curves., k. Cycling stability., l. Rate performance.

FIG. 4: a. SEM image of DMX powders after heat treatment without S. Scale bar 5 μm.

FIG. 5: Elemental mapping of thermally treated DMX/S using EDS.

FIG. 6: TEM images of a. DMX/S flakes, b. SAED pattern, c. EDS spectrum, d. Relative thickness map using EFTEM mode, the color is based on the electron mean free path scale, e. EFTEM mapping of Ti, f. EFTEM mapping of S.

FIG. 7: XPS analysis of DMX and DMX/S with C1s, O1s and S2p spectrum.

FIG. 8: TGA analysis of DMX/S.

FIG. 9: Electrochemical analysis of thermally treated DMX powders (without sulfur) in (a-b) Li system., a. CV curves., b. Cycling stability. (c-d) Na system., c. CV curves., d. Cycling stability. (e-f) K system., e. CV curves., f. Cycling stability.

FIG. 10: CV curves of DMX/S in Li—S system after first 20 cycles.

FIG. 11: CV curves of normal MXenes (without DHT treatment and after sulfur deposition).

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints (e.g., “between 2 grams and 10 grams, and all the intermediate values includes 2 grams, 10 grams, and all intermediate values”). The endpoints of the ranges and any values disclosed herein are not limited to the precise range or value; they are sufficiently imprecise to include values approximating these ranges and/or values. All ranges are combinable.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4. Further, the term “comprising” should be understood as having its open-ended meaning of “including,” but the term also includes the closed meaning of the term “consisting.” For example, a composition that comprises components A and B may be a composition that includes A, B, and other components, but may also be a composition made of A and B only. Any documents cited herein are incorporated by reference in their entireties for any and all purposes.

The Ti-based MXene, Ti₃C₂T_{Z}, obtained by etching Ti₃AlC₂ has shown unique properties such as high metallic conductivity (>5000 S·cm^{˜1}), high active surface area, and sufficient environmental stability²²⁻²⁵. The developed MXenes can be tuned with various surface functional groups as required for its applications adding to its versatility²⁶⁻³⁰. In addition to its unique properties, the interlayer spacing of MXenes can be controllably tuned^{22,31-33}. Physical mixing of MXene and S resulting in sandwich-type architecture has shown appealing performances in Li—S systems^{34,35}. However, these systems cannot function in carbonate-based electrolytes due to undesirable reactions as mentioned earlier. Herein, for the first time, we demonstrate the use of MXene host in carbonate electrolyte-based Li/Na/K—S batteries.

Alternate metal chemistries, beyond lithium, such as Na and K are interesting as they exhibit similar advantages as Li—S batteries, in addition to increased abundance and lower cost over Li. However, Na/K—S batteries face all the same challenges as Li—S systems such as rapid capacity fade and low electrochemical utilization. Additionally, they also suffer from more sluggish redox kinetics due to the larger ionic radius of Na⁺ (0.102 nm) and K⁺ (0.138 nm) vs Li⁺ (0.076 nm) resulting in the formation of only Na₂S₂ and K₂S₃ as the final discharge product, compared to Li₂S in Li—S system. Furthermore, the larger ionic size results in significantly higher volume expansion of 170% in Na—S, for example, vs 80% in Li—S further deteriorating cathode integrity³⁶. Such aggravated challenges coupled with inefficient cathode design result in reduced achievable capacity and stability in reported workss^{5,37,38}.

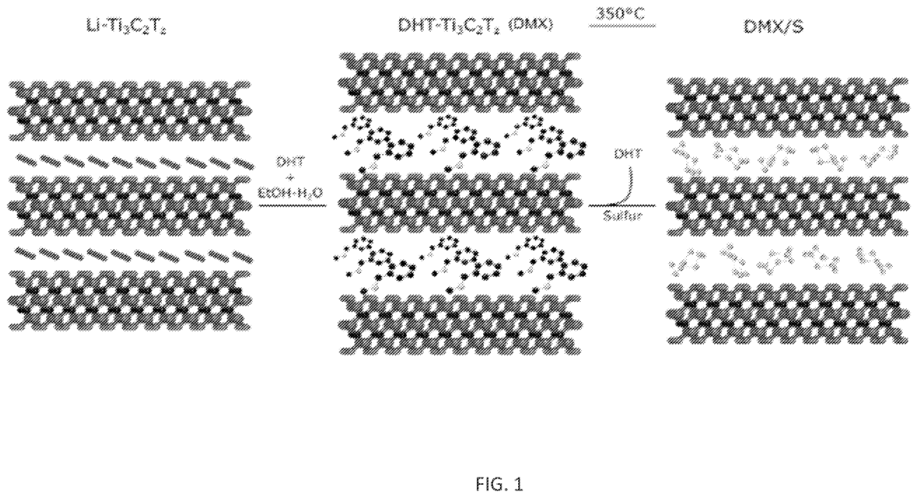

In this work, to enable the use of carbonate electrolytes in Li/Na/K—S batteries, we have focused on utilization of 2D MXene nanosheets as a host to confine sulfur within the inter-layer spacings with the objective to trigger ion de-solvation mitigating adverse carbonate-sulfur reactions. As mentioned above, herein, for the first time, we fabricate MXene-based sulfur cathodes that successfully operate in carbonate electrolytes in Li/Na/K systems. Moreover, this is the first-ever work that demonstrates the use of MXenes in any K—S battery system. To synthesize our cathodes, we first treated multilayered, ML, MXenes with di(hydrogenated tallow)benzyl methyl ammonium chloride (DHT) and used them as host materials due to their high interlayer spacing for enhanced S intercalation²². The DHT treated MXenes, henceforth referred to as DMX powders and S were hand mixed in a mortar and pestle in a 1:1 weight ratio and heated—in a house-designed closed, pipe fitting to 350° C. for 3 h in an inert environment. The mixture after thermal treatment will henceforth be referred to as a DMX/S. FIG. 1 is a schematic of what occurs during the thermal treatment.

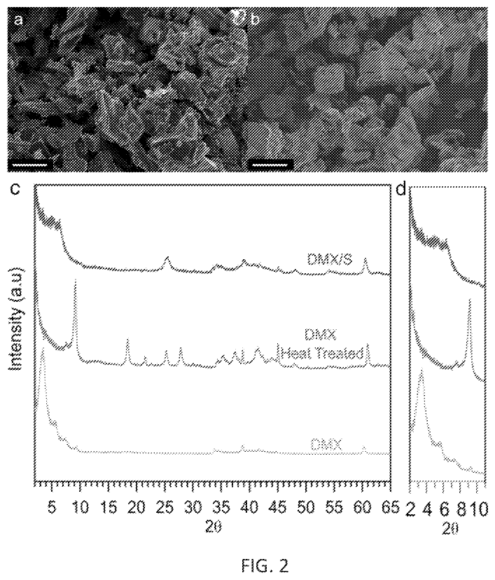

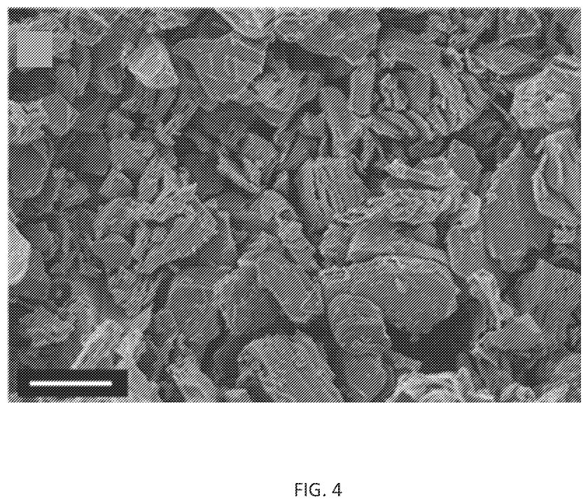

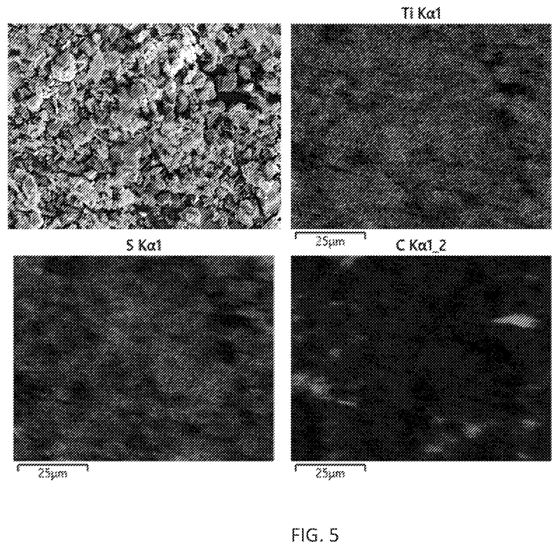

Scanning electron microscope (SEM) images show the composites retain multilayered (ML) structure with no aggregates before (FIG. 2a) and after thermal treatment (FIG. 2b). As a reference, we also thermally treated DMX (without sulfur) and it also shows a similar ML structure (FIG. 4) suggesting thermal treatment does not affect it. Elemental mapping using Energy-dispersive X-ray spectroscopy (EDS) further shows the presence of uniformly distributed S in the composite (FIG. 5)

FIG. 2c,d shows XRD patterns of the DMX, DMX/S, and heat-treated DMX powders. The XRD pattern of DMX/S shows peaks pertaining to MXenes with no evidence of crystalline S. The absence of crystalline peaks of octa-sulfur suggests it is present in an amorphous state. The 2θ peak corresponding to (002) plane represents the interlayer spacing between the MXene sheets. After thermal treatment in DMX/S, the intensity of that peak reduces substantially and broadens as seen in the zoomed-in XRD (2-10° 2θ) in FIG. 2d. The centre of the peak also shifts from about 3.9° to about 6.1° 2 θ, which corresponds to a reduction of interlayer spacing from 2.3 nm to 1.4 nm. The reduction in interlayer spacing suggests probable degradation of the DHT molecules leading to a decrease in interlayer spacing. Interestingly, the 002 peak shifts to 9.18° 2 θ for heat-treated DMX without sulfur, suggesting a significant decrease in interlayer spacing (0.9 nm). Comparing the d-spacing values of all three powders, suggests sulfur species mitigate the further collapse of the interlayer spacing in DMX powders with heat treatment suggesting the intercalation of sulfur species in between the DMX sheets.

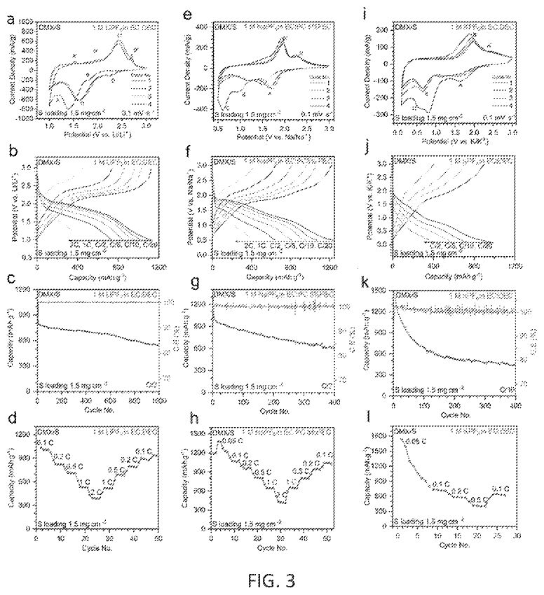

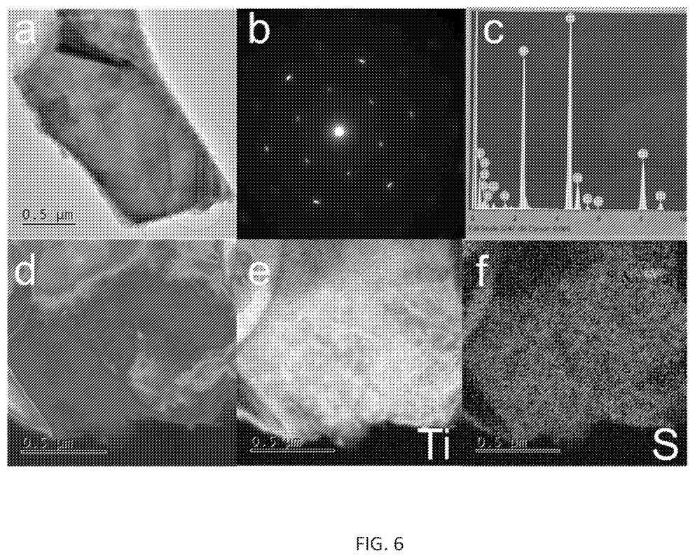

To get a deeper understanding of the S confinement in-between the MXene sheets, transmission electron microscopy (TEM) and its corresponding energy-filtered transmission electron microscopy mapping (EFTEM) experiments were conducted on DMX/S flakes. Typical TEM images of a flake show an ML structure as shown in FIG. 6a. Occasionally, small aggregates on the surface resulting from the oxidation of some MXene flakes to TiO₂ are observed. The selected area electron diffraction pattern (SAED) in FIG. 6b corresponds to the hexagonal pattern of MXenes. Diffused rings, corresponding to polycrystalline S, were not observed in the SAED pattern possibly due to their confinement in between the MLs. However, the EDS spectra (FIG. 6c) show the presence of S. EFTEM images acquired from a thin and uniform region (FIG. 6d) further corroborate the presence of S (Supp. FIG. 3f) that like the Ti (FIG. 6e) is uniformly distributed across the DMX/S flake.

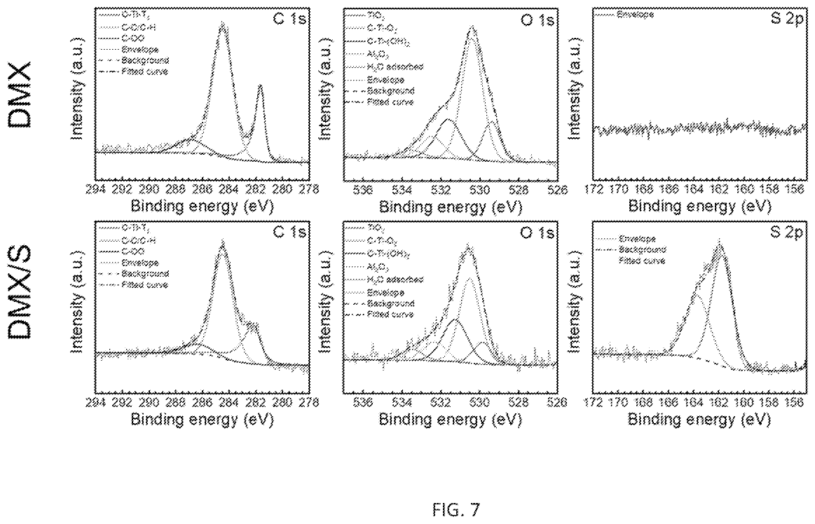

FIG. 7 shows the XPS spectra of MXene without (a-c) and with S after thermal treatment (d-f). The CIs spectra in both samples show the existence of the Ti—C—Ti MXene peaks in addition to surface adventitious C and C bonded to O at binding energies, BEs, 281.6, 284.6, and 286.8 eV, respectively²². There is ˜0.7 eV shift in the C—Ti-T_{z} peak in the C 1s spectra after sulfur intercalation due to possible interactions of sulfur atoms with the surface titanium atoms causing some shift in the electron density in the C—Ti bonds. This was added to the manuscript. The O1s spectra show the presence of TiO₂ species, which is possibly due to surface oxidation during the heat treatment. As expected, the high-resolution XPS spectra in the S2p region exhibit a doublet S2p_{3/2} and S2p_{1/2} in the MXene/S composite at BE's of 161.8 eV and 163.7 eV with an intensity ratio of 0.51 indicating the presence of S.

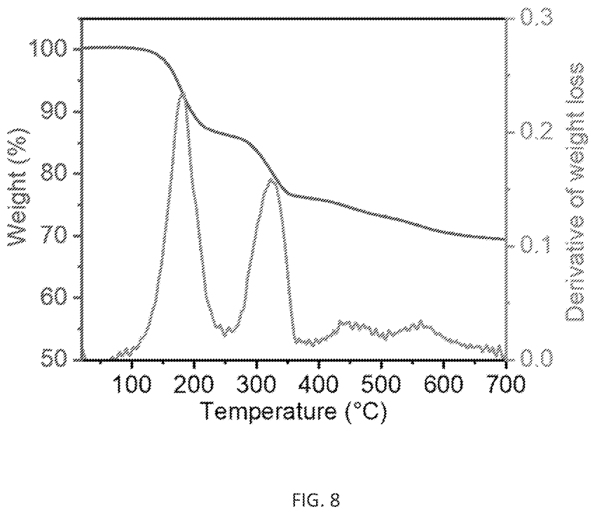

The DMX/S composite contains around 25 wt. % S in the composite as determined by thermogravimetric analysis TGA (FIG. 8). The TGA curves show two weight loss zones, one from 100-200° C. and another from 200-350° C. The first zone is associated with the S loss from the edges of the MXene sheets and in large pores; the latter from between the MXene layers³⁹. The enhanced thermal stability of the confined S can be attributed to its strong confinement and interaction with the MXenes sheets.

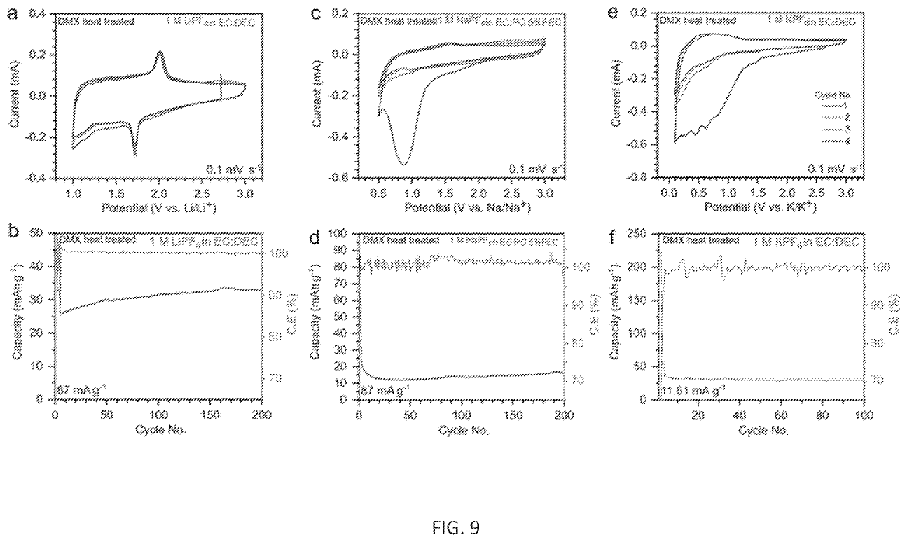

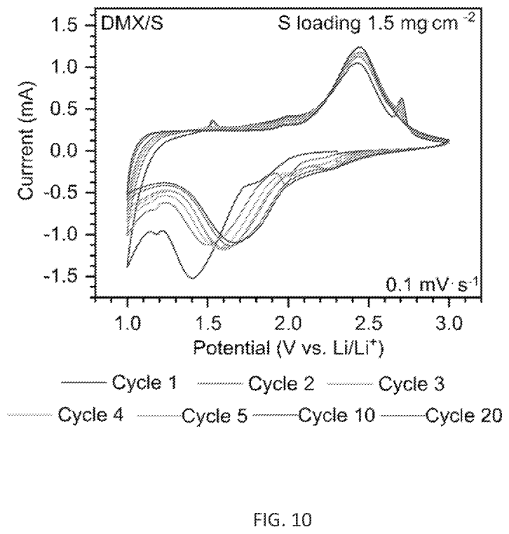

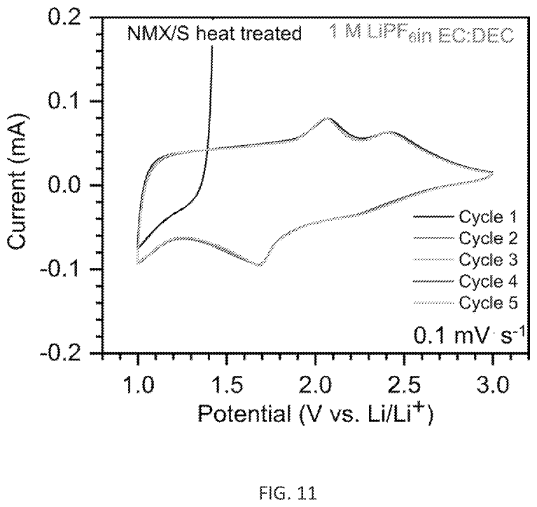

To test the electrochemical response of our DMX/S system, coin cells were assembled with DMX/S as the cathode and Li, Na or K foils as anodes. The electrolyte in the Li, Na, and K case was 1 M LiPF₆, 1 M NaPF₆ (EC:PC), and 1 M KPF₆, respectively in EC:DEC. In the Na system, 5 vol % fluoroethylene carbonate (FEC) was added to the electrolyte. FIG. 3 presents typical cyclic voltammetry, CV, curves, galvanostatic charge-discharge curves, and cycling tests of DMX/S cathodes in Li, Na, and K systems. The 1^{st} CV curve in the Li—S cell demonstrates three reduction and oxidation peaks in 1-3 V potential window vs. Li/Li⁺. The redox pair A-A′ is observed only in the 1^{st} cycle and can possibly be due to the irreversible redox behavior between the MXene nanosheets and the carbonate electrolyte (FIG. 3a). The redox pairs B-B′ and D-D′ are possibly due to intercalation and the pseudocapacitive behavior of MXene in organic electrolytes, respectively, as noted in previous reports^{40,41}. The redox pair B-B′ is also present in the thermally-treated DMX cathode (without S) as shown in FIG. 9a. Nevertheless, the capacity contribution from the B—B′ and D-D′ peaks is negligible and only present for the first 20 cycles (FIG. 10). After 10 cycles, the single redox pair C-C′—corresponds to the conversion of S₈ to Li₂S via a solid-state conversion, possibly due to the de-solvation of Li ions which dominates the charge transfer reaction^{16,42}. We believe the interlayer distance of MXene nanosheets after thermal treatment facilitates Li ion de-solvation leading to a quasi solid-state conversion. This possibly enables the intermediate polysulfides to remain within the stacked interlayers preventing contact and consequently adverse reactions with the carbonate solvent.^{18,43} A single broad peak in oxidation and reduction reactions is possibly an effect of a lower energy barrier for polysulfides to Li₂S conversion. Normal MXenes without DHT treatment subjected to sulfur deposition technique did not contribute to significant current response (FIG. 11). This suggests a requirement of higher initial interlayer spacing for sulfur intercalation which DMX host provides which reduces after thermal treatment, confining sulfur inbetween the sheets as depicted by the diffraction pattern in FIG. 3. The charge-discharge plateaus are consistent with the CV curves showing only a single plateau, unlike conventional ether-based Li—S redox reactions that show two plateaus.

The DMX/S electrode demonstrates a high discharge capacity of 1100 mAh/g at a C/10 rate in Li—S batteries. To estimate the capacity originating from the DMX host alone we performed the same charge-discharge tests at the same current per gram of active material (˜20 mA/g) as for the S composite and the capacity was only ˜35 mAh/g (FIG. 9b). It is clear that the host material does not contribute much to the capacity and it is indeed the S that is playing the dominant role. The long-term cycling was performed at C/2 rate and the DMX/S delivered 750 mAh/g (capacity retention=˜94%), 733 mAh/g (92%), 688 (86%) and 550 mAh/g (69%) after 100, 200, 500 and 1000 cycles, respectively. The cells were rested for 12 hours and conditioned at C/10 and C/5 for 2 cycles each. The cathode delivered an average Coulombic efficiency of 99.98% over 1000 cycles indicating complete utilization of S with negligible side and/or polysulfide reactions with the carbonate species. To further understand the cathode's behavior under various currents, rate analyses were performed. Such tests shed light on the mass diffusion of Li⁺ in the interlayer spacing. The DMX/S cathode delivered a capacity of 1050, 830, 730, 550, and 400 mAh/g at C/10, C/5, C/2, 1C, and 2C, respectively (FIG. 3d). Furthermore, when the current was decreased back to C/5 and C/10 the capacities rebounded to 800 and 950 mAh/g, respectively, demonstrating the robustness of the cathode towards electrochemical stresses.

The DMX/S cathodes were also cycled with a Na anode (FIG. 3e). The potential window was increased for complete conversion of the reduction peak. Although Li—/Na—S cells both have multistep redox reactions, the large size and poor mobility of Na ions complicate the electrochemical reactions of Na—S cells. The sluggish reaction kinetics cause high polarization that the operating voltage window, in turn, shifts toward lower discharge voltages of ≈0.5 V⁴⁴. The first reduction cycle shows three reduction peaks. We attribute the first peak at ˜1.5 V (A) to the reduction of S to Na₂S_{X}; the second at ˜0.9 V (B) to the decomposition of electrolyte and subsequent SEI formation; and the third peak, at ˜0.6 V (C), to further reduction of Na₂Sₓ (x=4-8) to Na₂S₂ and Na₂S⁴⁵⁻⁴⁷. In subsequent cycles, we see only two reduction peaks (A-A′ and C-C′) that can be associated with the formation of S to Na₂Sₓ followed by Na₂Sₓ to Na₂S₂ and Na₂S. We also observe a lower polarization gap during reduction cycles for similar conversions. For the first time compared to prior literature, we observe two dominant and repeatable redox pairs in the Na—S system with carbonate electrolyte. The two redox peaks demonstrated by DMX/S cathode coupled with Na anode show a striking difference compared to its use with Li anodes. Usually, a single pair of redox peaks are reported in the literature and are associated with the conversion of small S molecules (S₂-S₄) to Na₂S. However, here we believe S exists in its octasulfur polymorph (S₈) due to the relatively lower synthesis temperature used herein and the higher interlayer spacing (2.2 nm compared to <0.7 nm for microporous carbon) within the ML-DMX sheets is enabling successful intercalation/confinement of larger S₈ molecules. Traditionally, Na₂Sₓ is formed at ˜2.2 V, however, in our work, the peak is seen at ˜1.7 V (˜1.5 V in the first cycle), which could be attributed to the additional energy barrier needed for Na-ions to strip out the solvation shell (>1.8 nm) and diffuse into the narrow inter-layer spacing of the DMX sheets⁹. A lower peak voltage in the first cycle may be associated with the formation of an ion conductive SEI, alleviating the energy required for Na ions to intercalate into the DMX host⁴⁷. In the oxidation cycle, again, we observe two peaks related to the conversion of Na₂S to Na₂Sₓ and Na₂Sₓ to S₈. As discussed earlier, the successful repeatable operation in carbonate electrolyte suggests that the Na₂Sₓ formed, does not come in contact with the electrolyte owing to its confinement both within the MXene sheets and SEI layer.

To understand the electrochemical behavior of thermally treated DMX cathodes (without S) as a reference (FIG. 9c), DMX cathodes were cycled in the same electrolyte. A single reduction peak was observed at 0.9 V vs Na/Na⁺ in the first cycle (also seen in the first cycle of DMX/S), which is associated with the formation of SEI, after which the electrode delivers a double layer capacitance. Comparing the CV curves of DMX/S and DMX shows the existence of two additional redox peaks only in the DMX/S host, confirming their origin from S redox.

To further evaluate the electrochemical performance, galvanostatic charge-discharge tests were performed. The charge-discharge plateaus exhibit a similar trend as seen in CV curves (FIG. 3f). The DMX/S powders deliver an initial capacity of 1400 mAh/g at C/20 which is attributed to S₈ reduction to Na₂S and solvent decomposition resulting in SEI formation. An 1100 mAh/g capacity is retained after 1^{st} cycle. It is worth noting that the irreversible capacity loss possibly obtained with SET formation in the first cycle is relatively low and accounts for ˜300 mAh/g which can be associated with the low surface area of ML MXene sheets. The capacity stabilizes at 900 mAh/g after the first few cycles and delivers a capacity of 850 mAh/g (capacity retention=˜94.4%), 730 mAh/g (81%), 650 mAh/g (72.2%) and ˜600 mAh/g (˜67% capacity retention) after 100, 200, 300 and 400 cycles, respectively, at C/2 (FIG. 3g). The rate performance in FIG. 4h was evaluated at C/10, C/5, C/2, 1C, and 2C wherein the cathode delivered capacities of 1050, 950, 800, 600, and 400 mAh/g, respectively. Upon reducing the current to C/10, a capacity of 1000 mAh/g was recovered. The high capacity retention, at various current rates, can be attributed to the host conductivity and ion transport.

The electrochemical performance of DMX/S cathodes was further evaluated with K anodes. The DMX/S cathodes were cycled from 0.1-3.0 V wrt K/K⁺ in carbonate electrolyte. FIG. 4i shows the CV curves of DMX/S in the K—S system. The anodic curves show two reduction peaks, at 1.7 V (A) and a broad convoluted hump from 1.1-0.4 V (B & C) wrt K/K⁺. Based on our initial hypothesis on confinement of S₈ in the layered structure and de-solvation of K⁺ ions resulting in the reduction of the species, the first reduction peak can be attributed to the conversion of S₈ to K₂S_{X}⁴⁸. The broad hump probably is a combination of two peaks resulting from the reduction of electrolyte on the electrode surface, C (˜0.9 V wrt K/K⁺) and reduction of K₂S_{X} to K₂S₃, K₂S₂, and K₂S, B (˜0.7 V wrt K/K⁺)¹⁰. Compared to Li—S and Na—S systems, we need to shift the voltages of the K—S system to the lower end (0.1 V) to observe the complete conversion of the reaction due to its sluggish kinetics. In subsequent cycles, we observe only two sharp reduction peaks related to S₈ reduction at 1.6 V and 0.7 V wrt K/K⁺. During the oxidation cycle, we observe two peaks at 2 V and 2.5 V wrt K/K⁺ demonstrating the conversion of solid K₂S to K₂S_{X} and K₂S_{X} to S₈, respectively. Xiong et al., reported infusion of small S molecules in microporous carbon with high temperature treatment (˜600° C.), and observed two reduction peaks positioned at 1.5 and 0.85 V wrt K/K⁺. However, the scan rate employed in the literature is low (0.01 mV/s) compared to this study (0.1 mV/s) which results in peak shifts⁴⁸. Interestingly, they observed two peaks similar to the current study despite the presence of small S molecules as the active material. We believe the SEI layer formed in the first cycle prevents the interaction of the electrolyte with the S species and consequently any adverse reactions. Also, similar to the Na—S system the increased polarization gap in between redox reactions results in the observation of two peaks in the K—S system compared to a single peak in Li—S. The charge-discharge plateaus obey similar patterns as the CV curves.

The cathode delivers an initial capacity of ˜1700 mAh/g at C/20 which is higher than the theoretical capacity of S₈ denoting some capacity is originating from the reduction of S₈ as well as the irreversible reduction of the electrolyte (SEI) in the first cycle. The capacity then reduces at ˜1400 mAh/g in subsequent cycles which is expected to be fully attributable to the S₈ reduction reaction. The cathode delivers a capacity of 700 mAh/g, 500 mAh/g, 450 mAh/g, and 400 mAh/g after 100, 200, 300 and 400 cycles, respectively, at a C/10 current rate. The rapid decrease in capacity can be attributed to the larger K⁺ ions (0.276 nm) rupturing the SEI layer and eliminating the confinement effect. However, further study needs to be done to understand this effect completely. Due to sluggish kinetics the rate capability was performed at C/20, C/10, C/5, and C/2 as shown in FIG. 4i, wherein the cathode delivered a capacity of 900, 700, 600, and 400 mAh/g, respectively. For comparison, we cycled the thermally treated DMX (without S) in the similar voltage range with similar gravimetric current densities (FIG. 9 e,f). A single reduction peak in the 1^{st} cycle is attributed to SEI formation and is also observed for DMX/S cathode, after which the electrode delivers a double layer capacitance in subsequent cycles. During the charge-discharge tests the capacity contribution is higher compared to Li—S and Na—S system due to the lower current density in K—S system.

In conclusion, for the first time, we demonstrate the utilization of highly conductive MXene sheets as a confinement source for S8 molecules enabling solid-state conversion in carbonate electrolytes in alkali metal (Li/Na/K)—S systems. Compared to conventional liquid phase Li—S electrochemical reactions, this quasi-solid-state mechanism has various advantages, which can provide a new paradigm for future metal-S battery materials design and synthesis. Our findings provide a universal host to fabricate high-performance room-temperature alkali metal-S batteries using carbonate electrolyte, a more commercially viable choice.

### EXAMPLES

The following disclosure is illustrative only and does not limit the scope of the present disclosure or the appended claims.

### 1. Experimental

### 1.1 Materials

### Material for Synthesis:

Titanium carbide (TiC) (99.5%, 2 μm), aluminum (Al) (99.5%, 325 mesh), and titanium (Ti) (99.5%, 325 mesh) and LiF (99.5%, 325 mesh) were purchased from Alfa Aesar.12 M HCl was purchased from Fisher Scientific and DHT (80%) was purchased from Alfa Chemistry.

### Materials for Electrochemistry:

Sulfur (99.5%, sublimed, catalog number AC201250025) was purchased from Fisher scientific. Battery grade Ethylene carbonate, Diethyl carbonate, Propylene carbonate, Fluoro-ethylene carbonate, Lithium hexafluorophosphate, Sodium hexafluorophosphate and Potassium hexafluorophosphate were purchased from Sigma Aldrich.

### 1.2 Synthesis

### 1.2.1 Synthesis of MAX Powder (Ti3AlC2)

Parent Ti₃AlC₂ powders were synthesized by mixing titanium carbide (TiC), aluminum (Al), and titanium (Ti) powders in a molar ratio of 2:1.05:1, respectively. The mixed powders were ball milled at 100 rpm for 24 h and then heated under argon (Ar) flow at 1350° C. for 2 h. It should be noted that the ball milling at slow speed was only for homogenous mixing no particle size reduction or reactions are occurring. The heating and cooling rates were set at 5° C./min. The resulting blocks were ground to powders using a milling bit on a drill press. The milled powders were passed through a 400-mesh (particle size <38 μm) sieve for further experiments.

1.2.2 Synthesis of MXene (Ti₃C₂T_{z}) and DHT Treatment:

First, 1 g of LiF was dissolved in 10 mL of 12 M HCl after which 1 g of the Ti₃AlC₂ powder was slowly added to the solution. Then it was stirred for 24 h at 35° C. and 300 rpm. The resulting solution was later transferred into a 50 mL centrifuge tube, and deionized (DI) water was added to completely fill the remaining volume. It was then centrifuged at 3500 rpm/2300 rcf for 1 min, and the resulting clear supernatant was discarded. This washing was repeated several times until the pH of the solution was ≈7. Afterward the sediment was divided into 2 equal parts. One part was dried in a vacuum at 100° C. for 12 h and is labeled as normal untreated MXene (NMX). In the second part, 40 mL of a 20-mM pre-prepared solution of DHT in a 50:50 (v:v) of water and ethanol was added and allowed to mix for 12 h at RT. After mixing, all of the powders were washed with DI water 3 times. The resulting DHT-MXene or DMX dried in a vacuum at 100° C. for 12 h.

### 1.2.3 Synthesis of MXene-Sulfur Composite:

Moderate weight percentage electrodes, 50 wt %

In a typical synthesis, 0.1 g of dried DMX was mixed with 0.1 g of sulfur and ground with mortar-pestle until the mixture was uniform. Later, this solid mixture was transferred in a glass test tube and then into an argon-filled glove box, where the top was physically closed with a coin-cell spacer and sealed with Teflon tape. This assembly was further loaded in a house-made reactor consisting of a 6-inch SS pipe fitting and closed in the glove box with pipe caps and then transferred out. Further, this reactor was loaded in a horizontal tube furnace at 350° C. for 3 h at a rate of 2° C./min in an argon environment.

### 1.2.4 Synthesis of DMX/S Composite Electrode:

A cathode was fabricated using a slurry method. Briefly, the slurry was prepared by mixing 80 wt % of vacuum-dried DMX/S with 10 wt % conductive carbon (Alfa Aesar, Super P) and 10 wt % battery grade PVDF binder (MTI corp, USA). DMX/S, conductive carbon and PVDF were hand-ground with mortar and pestle till the composite turned uniform. Later N-Methyl-2-pyrrolidone (TCI, USA) was slowly added until required visible consistency and uniformity were achieved (˜1 h). The slurry was later cast on battery grade aluminum foil using a doctor blade (MTI corp, USA) with a thickness of 30-120 μm. Once cast, the slurry was kept under a closed fume hood for 2 hours before transferring to a vacuum oven where it was dried at 50° C. for 24 h.

### 2. Characterization

### 2.1 Material Characterization

The morphological analysis of the materials was conducted using an SEM (Zeiss Supra 50VP, Germany) with an in-lens detector and 30 mm aperture was used to examine the morphology and obtain micrographs of the samples. To analyze the surface elemental composition, EDS (Oxford Instruments) in secondary electron detection mode was used. To analyze the sulfur deposition on the surface TEM measurements were conducted. High-resolution transmission electron microscope, HR-TEM, analyses were performed in a bright field mode operated at 200 kV on a JEOL JEM2100F equipped with an energy dispersive spectroscope, EDS, with an 80 mm2 SSD detector (Oxford X-MaxN 80 T EDS system). X-ray diffraction (XRD) patterns were acquired on a diffractometer (Rigaku Miniflex, Tokyo, Japan) using Cu Ka radiation (40 kV and 40 mA) with a step size of 0.02° and dwell time of 5 s, in the 2°-65° 2θ range. The surface of the composites was analyzed with X-ray photoelectron spectroscopy (XPS). To collect XPS spectra, Al-Ka X-rays with a spot size of 200 mm and pass energy of 23.5 eV were used to irradiate the sample surface. A step size of 0.05 eV was used to gather the high-resolution spectra. CasaXPS Version 23.19PR1.0 software was used for spectra analysis. The sulfur in the composite was determined using Thermogravimetric analysis (TGA) on a TA Instruments Q50. The samples were heated at a ramp rate of 10° C. min⁻¹ to 800° C. under flowing Argon gas.

### 2.2 Electrochemical Characterization

### 2.2.1 Coin Cell Fabrication

The dried electrodes were cut using a hole punch (ϕ=½ inch (12.72 mm)) to form disk sized electrodes. The electrodes were then weighed and transferred to an argon-filled glove box (MBraun Lab star, O2<1 ppm, and H2O<1 ppm). The CR2032 (MTI Corporation and Xiamen TMAX Battery Equipment) coin-type Li—S cells were assembled using DMX/S (ϕ=12 mm), lithium disk anodes (Xiamen TMAX Battery Equipment's; (ϕ=15.6 mm and 450 μm thick), a tri-layer separator (Celgard 2325; ϕ=19 mm), and one stainless steel spring and two spacers along with an electrolyte. The electrolytes, 1 M LiPF₆ in EC:DEC (1:1), 1 M NaPF₆ in EC:PC (1:1) with 5% FEC and 1M KPF₆ in EC:DEC (1:1), were made after pre drying the solvent with molecular sieves. The assembled coin cells were rested at their open-circuit potential for 12 h to equilibrate them before performing electrochemical experiments at room temperature. Cyclic voltammetry was performed at various scan rates (0.1 mV·s⁻¹ to 0.5 mV·s⁻¹) between voltages 0.1 and 3 V wrt Li/Li⁺, Na/Na⁺ and K/K⁺ were performed using a potentiostat (Biologic VMP3). Prolonged cyclic stability tests were carried out with a MACCOR (4000 series) and Neware BTS 4000 battery cycler at different C-rates (where 1 C=1675 mAh.g−1) between voltages 0.1 and 3.0 V. All cells were conditioned during the first cycle at the 0.1 C and second cycle at 0.2 C rate before cycling them at the 0.5 C rate at room temperature.

### REFERENCES

1. Padhi, A. K., et al., Phospho-olivines as Positive-Electrode Materials for Rechargeable Lithium Batteries, Journal of The Electrochemical Society (1997) 144 (4), 1188-1194, 10.1149/1.1837571
2. Li, M., et al., 30 Years of Lithium-Ion Batteries, Adv Mater (2018), e1800561, 10.1002/adma.201800561
3. Bruce, P. G., et al., Li—O2 and Li—S batteries with high energy storage, Nat Mater (2011) 11(1), 19-29, 10.1038/nmat3191
4. Manthiram, A., et al., Rechargeable lithium-sulfur batteries, Chem Rev (2014) 114 (23), 11751-11787, 10.1021/cr500062v
5. Chung, S. H., and Manthiram, A., Current Status and Future Prospects of Metal-Sulfur Batteries, Adv Mater (2019) 31 (27), e1901125, 10.1002/adma.201901125
6. Wild, M., et al., Lithium sulfur batteries, a mechanistic review, Energy & Environmental Science (2015) 8 (12), 3477-3494, 10.1039/c5ee01388g
7. Yin, Y. X., et al., Lithium-sulfur batteries: electrochemistry, materials, and prospects, Angew Chem Int Ed Engl (2013) 52 (50), 13186-13200, 10.1002/anie.201304762
8. Xin, S., et al., A high-energy room-temperature sodium-sulfur battery, Adv Mater (2014) 26 (8), 1261-1265, 10.1002/adma.201304126
9. Wei, S., et al., A stable room-temperature sodium-sulfur battery, Nat Commun (2016) 7, 11722, 10.1038/ncomms11722
10. Ding, J., et al., Review of Emerging Potassium-Sulfur Batteries, Adv Mater (2020) 32 (23), e1908007, 10.1002/adma.201908007
11. Wang, L., et al., Development and Challenges of Functional Electrolytes for High-Performance Lithium-Sulfur Batteries, Advanced Functional Materials (2018) 28 (38)10.1002/adfm.201800919
12. Flamme, B., et al., Guidelines to design organic electrolytes for lithium-ion batteries: environmental impact, physicochemical and electrochemical properties, Green Chemistry (2017) 19 (8), 1828-1849, 10.1039/c7gc00252a
13. Cleaver, T., et al., Perspective-Commercializing Lithium Sulfur Batteries: Are We Doing the Right Research?, Journal of The Electrochemical Society (2017) 165 (1), A6029-A6033, 10.1149/2.0071801jes
14. Zhang, S. S., Liquid electrolyte lithium/sulfur battery: Fundamental chemistry, problems, and solutions, Journal of Power Sources (2013) 231, 153-162, 10.1016/j.jpowsour.2012.12.102
15. Yim, T., et al., Effect of chemical reactivity of polysulfide toward carbonate-based electrolyte on the electrochemical performance of Li—S batteries, Electrochimica Acta (2013) 107, 454-460, 10.1016/j.electacta.2013.06.039
16. Helen, M., et al., Insight into Sulfur Confined in Ultramicroporous Carbon, ACS Omega (2018) 3 (9), 11290-11299, 10.1021/acsomega.8b01681
17. Maria Joseph, H., et al., Perspective on ultramicroporous carbon as sulphur host for Li—S batteries, Journal ofEnergy Chemistry (2021) 59, 242-256, 10.1016/j.jechem.2020.11.001
18. Markevich, E., et al., Review—On the Mechanism of Quasi-Solid-State Lithiation of Sulfur Encapsulated in Microporous Carbons: Is the Existence of Small Sulfur Molecules Necessary?, Journal of The Electrochemical Society (2016) 164 (1), A6244-A6253, 10.1149/2.0391701jes
19. Naguib, M., et al., Two-dimensional nanocrystals produced by exfoliation of Ti3 A1C2, Adv Mater (2011) 23 (37), 4248-4253, 10.1002/adma.201102306
20. Verger, L., et al., MXenes: An Introduction of Their Synthesis, Select Properties, and Applications, Trends in Chemistry (2019) 1(7), 656-669, 10.1016/j.trechm.2019.04.006
21. Sokol, M., et al., On the Chemical Diversity of the MAX Phases, Trends in Chemistry (2019) 1(2), 210-223, 10.1016/j.trechm.2019.02.016
22. Carey, M., et al., Dispersion and Stabilization of Alkylated 2D MXene in Nonpolar Solvents and Their Pseudocapacitive Behavior, Cell Reports Physical Science (2020) 1(4)10.1016/j.xcrp.2020.100042
23. Hantanasirisakul, K., et al., Fabrication of Ti3C2TxMXene Transparent Thin Films with Tunable Optoelectronic Properties, Advanced Electronic Materials (2016) 2 (6)10.1002/aelm.201600050
24. Ghidiu, M., et al., Conductive two-dimensional titanium carbide ‘clay’ with high volumetric capacitance, Nature (2014) 516 (7529), 78-81, 10.1038/nature13970
25. Anasori, B., et al., 2D metal carbides and nitrides (MXenes) for energy storage, Nature Reviews Materials (2017) 2 (2)10.1038/natrevmats.2016.98
26. Dillon, A. D., et al., Highly Conductive Optical Quality Solution-Processed Films of 2D Titanium Carbide, Advanced Functional Materials (2016) 26 (23), 4162-4168, 10.1002/adfm.201600357
27. Hantanasirisakul, K., and Gogotsi, Y., Electronic and Optical Properties of 2D Transition Metal Carbides and Nitrides (MXenes), Adv Mater (2018) 30 (52), e1804779, 10.1002/adma.201804779
28. Kamysbayev, V., et al., Covalent surface modifications and superconductivity of two-dimensional metal carbide MXenes, Science (2020) 369 (6506), 979-983, 10.1126/science.aba8311
29. Han, D., et al., Two-dimensional materials for lithium/sodium-ion capacitors, Materials Today Energy (2019) 11, 30-45, https://doi.org/10.1016/j.mtener.2018.10.013
30. Etman, A. S., et al., Mo1.33CTz-Ti3C2Tz mixed MXene freestanding films for zinc-ion hybrid supercapacitors, Materials Today Energy (2021) 22, 100878, https://doi.org/10.1016/j.mtener.2021.100878
31. Ghidiu, M., et al., Ion-Exchange and Cation Solvation Reactions in Ti3C2MXene, Chemistry of Materials (2016) 28 (10), 3507-3514, 10.1021/acs.chemmater.6b01275
32. Liu, M.-C., et al., Regulating interlayer spacing with pillar and strain structures in Ti3C2 MXene layers by molecular welding for superior alkali metal ion storage, Materials Today Energy (2021) 22, 100832, https://doi.org/10.1016/j.mtener.2021.100832
33. Ruan, T., et al., Interface coupling in FeOOH/MXene heterojunction for highly reversible lithium-ion storage, Materials Today Energy (2021) 19, 100584, https://doi.org/10.1016/j.mtener.2020.100584
34. Zhao, Q., et al., Status and Prospects of MXene-Based Lithium-Sulfur Batteries, Advanced Functional Materials (2021) 10.1002/adfm.202100457
35. Pai, R., et al., Tuning functional two-dimensional MXene nanosheets to enable efficient sulfur utilization in lithium-sulfur batteries, Cell Reports Physical Science (2021) 2 (7), 100480, https://doi.org/10.1016/j.xcrp.2021.100480
36. Hueso, K. B., et al., High temperature sodium batteries: status, challenges and future trends, Energy & Environmental Science (2013) 6 (3)10.1039/c3ee24086j
37. Kumar, D., et al., Progress and prospects of sodium-sulfur batteries: A review, Solid State Ionics (2017) 312, 8-16, 10.1016/j.ssi.2017.10.004
38. Zhao, X., et al., Potassium-sulfur batteries: Status and perspectives, EcoMat (2020) 2 (3)10.1002/eom2.12038
39. Xue, M., et al., Mangosteen peel-derived porous carbon: synthesis and its application in the sulfur cathode for lithium sulfur battery, Journal of Materials Science (2018) 53 (15), 11062-11077, 10.1007/s10853-018-2370-9
40. Naguib, M., et al., MXene: a promising transition metal carbide anode for lithium-ion batteries, Electrochemistry Communications (2012) 16 (1), 61-64, 10.1016/j.elecom.2012.01.002
41. Kurra, N., et al., Bistacked Titanium Carbide (MXene) Anodes for Hybrid Sodium-Ion Capacitors, ACS Energy Letters (2018) 3 (9), 2094-2100, 10.1021/acsenergylett.8b01062
42. Fu, C., et al., Solid state lithiation-delithiation of sulphur in sub-nano confinement: a new concept for designing lithium-sulphur batteries, Chem Sci (2016) 7 (2), 1224-1232, 10.1039/c5sc03419a
43. Xin, S., et al., Smaller sulfur molecules promise better lithium-sulfur batteries, J Am Chem Soc (2012) 134 (45), 18510-18513, 10.1021/ja308170k
44. Yan, Z., et al., A High-Kinetics Sulfur Cathode with a Highly Efficient Mechanism for Superior Room-Temperature Na—S Batteries, Adv Mater (2020) 32 (8), e1906700, 10.1002/adma.201906700
45. Kajiyama, S., et al., Sodium-Ion Intercalation Mechanism in MXene Nanosheets, ACS Nano (2016) 10 (3), 3334-3341, 10.1021/acsnano.5b06958
46. Cheng, X. B., et al., A Review of Solid Electrolyte Interphases on Lithium Metal Anode, Adv Sci (Weinh) (2016) 3 (3), 1500213, 10.1002/advs.201500213
47. Lee, J., et al., A review on recent approaches for designing the SEI layer on sodium metal anodes, Materials Advances (2020) 1 (9), 3143-3166, 10.1039/dOma00695e
48. Xiong, P., et al., Room-Temperature Potassium-Sulfur Batteries Enabled by Microporous Carbon Stabilized Small-Molecule Sulfur Cathodes, ACS Nano (2019) 13 (2), 2536-2543, 10.1021/acsnano.8b09503

### ASPECTS

The following Aspects are illustrative only and do not limit the scope of the present disclosure or the appended claims. Any part or parts of any one or more Aspects can be combined with any part or parts of any one or more other Aspects.

Aspect 1. A composite, comprising: a layered structure comprising at least two layers, and an amount of a chalcogen confined between the at least two layers.

Aspect 2. The composite of Aspect 1, wherein the chalcogen is sulfur.

Aspect 3. The composite of Aspect 1, wherein the layered structure is a MXene.

In general, MXenes adopt structures with one metal on the M site, as inherited from the parent MAX phases: M₂C, M₃C₂, and M₄C₃. Ordered double transition metal MXenes can have the general formula: M′₂M″C₂ or M′₂M″₂C₃ where M′ and M″ are different transition metals. Solid solution MXenes can have the general formula: (M′_{2-y}M″_{y})C, (M′_{3-y}M″_{y})C₂, (M′_{4-y}M″_{y})C₃, or (M′_{5-y}M″_{y})C₄, where the metals are randomly distributed throughout the structure in solid solutions leading to continuously tailorable properties.

A MXene composition can be, e.g., any of the compositions described in at least one of U.S. patent application Ser. No. 14/094,966 (filed Dec. 3, 2013), 62/055,155 (filed Sep. 25, 2014), 62/214,380 (filed Sep. 4, 2015), 62/149,890 (filed Apr. 20, 2015), 62/127,907 (filed Mar. 4, 2015) or International Applications PCT/JS2012/043273 (filed Jun. 20, 2012), PCT/US2013/072733 (filed Dec. 3, 2013), PCT/US2015/051588 (filed Sep. 23, 2015), PCT/US2016/020216 (filed Mar. 1, 2016), or PCT/US2016/028,354 (filed Apr. 20, 2016), PCT/US2020/054912 (filed Oct. 9, 2020); preferably where the MXene composition comprises titanium and carbon (e.g., Ti₃C₂, Ti2_{C}, Mo₂TiC₂, and the like).

Aspect 4. The composite of any one of Aspects 1-3, wherein the composite is present in flake, ribbon, or rectangle form.

Aspect 5. The composite of any one of Aspects 1-4, wherein the composite comprises an amount of a cationic surfactant disposed thereon, the cationic surfactant optionally comprising a quaternary ammonium cation.

Aspect 6. The composite of Aspect 5, wherein the quaternary ammonium cation comprises di(hydrogenated tallow)benzyl methyl ammonium.

Aspect 7. The composite of any one of Aspects 1-6, wherein the sulfur represents from about 0.01 to about 80 wt % of the composite.

Aspect 8. The composite of any one of Aspects 1-7, further comprising a conductive material.

Aspect 9. The composite of Aspect 8, wherein the conductive material comprises a polymer.

Aspect 10. The composite of Aspect 8, wherein the conductive material comprises carbon.

Aspect 11. The composite of any one of Aspects 1-10, wherein the chalcogen is distributed essentially uniformly between the two layers. As an example, the chalcogen (e.g., sulfur) can be distributed essentially uniformly between the two layers without there being sulfur located other than between the two layers.

Aspect 12. An electrode, comprising a composite according to any one of Aspects 1-11.

Aspect 13. The electrode of Aspect 12 wherein the electrode is a cathode.

Aspect 14. The electrode of Aspect 13, wherein the cathode exhibits an average Coulombic efficiency of at least 50% over 1000 cycles.

Aspect 15. The electrode of Aspect 14, wherein the cathode exhibits an average Coulombic efficiency of at least 97% over 1000 cycles.

Aspect 16. A power cell, comprising: a first electrode according to any one of Aspects 12-15; a second electrode; and an electrolyte, the electrolyte optionally comprising a solid oxide or a sulfide.

Aspect 17. The power cell of Aspect 16, wherein the electrolyte comprises an ether or a carbonate, the carbonate optionally comprising one or more of ethylene carbonate (or other linear alkyl carbonate), dimethyl carbonate, ethyl methyl carbonate, vinylene carbonate, fluoro ethylene carbonate, n-propyl propionate, and propylene carbonate. The carbonate can also include, e.g., a cyclic alkyl carbonate. The carbonate can also include propylene carbonate, ethylene carbonate, and the like.

Aspect 18. The power cell of Aspect 16, wherein the electrolyte comprises an ether, an ionic liquid, or a solid electrolyte, the ether optionally comprising one or more of dioxlane, dimethyl ether, tetra methyl ether, and tetraethylene glycol dimethyl ether.

Aspect 19. The power cell of any one of Aspects 16-18, wherein the second electrode comprises an alkali metal, the second electrode optionally comprising one or more of graphite, silicone—graphite composite, copper foil, carbon, and lithiated carbon.

Aspect 20. A method, comprising: with an intercalant spacer, effecting an increase in an interlayer spacing in a multilayered composition to give rise to a multilayered composition having enhanced interlayer spacing, the multilayered composition having enhanced interlayer spacing optionally comprising a MXene; and contacting the multilayered composition having enhanced interlayer spacing and a chalcogen to effect intercalation of the chalcogen into the interlayer spacing so as to confine the chalcogen between layers of the multilayered composition, the weight ratio of the chalcogen and the multilayered composition having enhanced interlayer spacing optionally being from about 1:5 to 5:1,and optionally effecting removal of the intercalant spacer so as to give rise to a chalcogen-intercalated multilayered composition.

Aspect 21. The method of Aspect 20, wherein the intercalant spacer comprises an amount of a quaternary ammonium cation.

Aspect 22. The method of Aspect 21, wherein the quaternary ammonium cation comprises di(hydrogenated tallow)benzyl methyl ammonium.

Aspect 23. The method of any one of Aspects 20-22, wherein the chalcogen is sulfur.

Aspect 24. The method of any one of Aspects 20-23, comprising contacting the multilayered composition with the intercalant spacer.

Aspect 25. The method of Aspect 24, further comprising washing excess intercalant spacer.

Aspect 26. The method of any one of Aspects 20-25, further comprising heating the multilayered composition having enhanced interlayer spacing and the chalcogen at from about 250 to about 500° C.

Aspect 27. The method of Aspect 26, wherein the heating is performed in an inert environment.

Aspect 28. The method of Aspect 27, wherein the environment comprises a noble gas.

1. A composite, comprising:
a layered structure comprising at least two layers, and
an amount of a chalcogen confined between the at least two layers.

2. The composite of claim 1, wherein the chalcogen is sulfur.

3. The composite of claim 1, wherein the layered structure is a MXene.

4. The composite of claim 1, wherein the composite is present in flake, ribbon, or rectangle form.

5. The composite of claim 1, wherein the composite comprises an amount of a cationic surfactant disposed thereon, the cationic surfactant optionally comprising a quaternary ammonium cation.

6. The composite of claim 5, wherein the cationic surfactant comprises di(hydrogenated tallow)benzyl methyl ammonium (DHT).

7. The composite of claim 2, wherein the sulfur represents from about 0.01 to about 80 wt % of the composite.

8. The composite of claim 1, further comprising a conductive material.

9. The composite of claim 8, wherein the conductive material comprises a polymer.

10. The composite of claim 8, wherein the conductive material comprises carbon.

11. The composite of claim 1, wherein the chalcogen is distributed essentially uniformly between the two layers.

12. An electrode, comprising a composite according to claim 1.

13. The electrode of claim 12, wherein the electrode is a cathode.

14. The electrode of claim 13, wherein the cathode exhibits an average Coulombic efficiency of at least 50% over 1000 cycles.

15. The electrode of claim 14, wherein the cathode exhibits an average Coulombic efficiency of at least 97% over 1000 cycles.

16. A power cell, comprising:
a first electrode according to claim 12;
a second electrode; and
an electrolyte, the electrolyte optionally comprising a solid oxide or a sulfide.

17. The power cell of claim 16, wherein the electrolyte comprises an ether or a carbonate, the carbonate optionally comprising one or more of ethylene carbonate, dimethyl carbonate, ethyl methyl carbonate, vinylene carbonate, fluoro ethylene carbonate, n-propyl propionate, and propylene carbonate.

18. The power cell of claim 16, wherein the electrolyte comprises an ether, an ionic liquid, or a solid electrolyte, the ether optionally comprising one or more of dioxlane, dimethyl ether, tetra methyl ether, and tetraethylene glycol dimethyl ether.

19. The power cell of claim 16, wherein the second electrode comprises an alkali metal, the second electrode optionally comprising one or more of graphite, silicone-graphite composite, copper foil, carbon, and lithiated carbon.

20. A method, comprising:
with an intercalant spacer, effecting an increase in an interlayer spacing in a multilayered composition to give rise to a multilayered composition having enhanced interlayer spacing, the multilayered composition having enhanced interlayer spacing optionally comprising a MXene; and
contacting the multilayered composition having enhanced interlayer spacing and a chalcogen to effect intercalation of the chalcogen into the interlayer spacing so as to confine the chalcogen between layers of the multilayered composition, a weight ratio of the chalcogen and the multilayered composition having enhanced interlayer spacing optionally being from about 1:5 to 5:1, and
optionally effecting removal of the intercalant spacer so as to give rise to a chalcogen-intercalated multilayered composition.

21. The method of claim 20, wherein the intercalant spacer comprises an amount of a quaternary ammonium cation.

22. The method of claim 21, wherein the quaternary ammonium cation comprises di(hydrogenated tallow)benzyl methyl ammonium.

23. The method of claim 20, wherein the chalcogen is sulfur.

24. The method of claim 20, comprising contacting the multilayered composition with the intercalant spacer.

25. The method of claim 24, further comprising washing excess intercalant spacer.

26. The method of claim 20, further comprising heating the multilayered composition having enhanced interlayer spacing and the chalcogen at from about 250 to about 500° C.

27. The method of claim 26, wherein the heating is performed in an inert environment.

28. The method of claim 27, wherein the environment comprises a noble gas.
